(19) United States
(12) Patent Application Publication
(10) Pub. No.: US 2023/0090647 A1
(43) Pub. Date: Mar. 23, 2023

(54) SECURING DEVICE FOR ELECTRIC BICYCLE MOTOR

(71) Applicant: GLOBAL PROSPECTIVE COOPERATION COMPANY, TAINAN CITY (TW)

(72) Inventors: PIN-CHIA CHEN, TAINAN CITY (TW); JER-JIA SHEU, TAINAN CITY (TW); CHO-YIN LEE, TAINAN CITY (TW)

(21) Appl. No.: 18/058,748

(22) Filed: Nov. 24, 2022

(30) Foreign Application Priority Data
Feb. 26, 2021 (TW) 110144283
Feb. 26, 2021 (TW) 110144284

(51) Int. Cl. B62M 6/55

(52) U.S. Cl. CPC B62M 6/55

(57) ABSTRACT

A securing device for securing a mid-mount motor of an electric bicycle includes a casing composed of a first part and a second part which is snugly mounted to the first part by locking members. The motor is accommodated in a room of the casing. The second part includes an end face facing the first part. A slot is formed in the second part and has a hole formed in the inner bottom of the slot. A locking member extends through a flange of the first part and the hole in the second part, and is connected to a nut located in the slot. The nut does not rotate to ensure that the first and second parts are securely connected with each other. The heat from the motor is transferred to the bike frame. Multiple deformation sensors are installed to the casing to provide precise detection data to the processor.

### BACKGROUND OF THE INVENTION

### 1. Fields of the invention

The present invention relates to a securing device, and more particularly, to a securing device for securing a mid-mount motor of an electric bicycle.

### 2. Descriptions of Related Art

In order to improve the stability of the output power and comfort when pedaling an electric bicycle, an electric bicycle with a pedal torque detection device is supposed to have an ideal torque curve value of the crank at each rotation angle of 360-degree pedaling. An ideal electric assist control is to control the electric assist torque so that the pedal torque of the rider is the same as the ideal torque curve value. However, there is no such electric bicycle that meets the above ideal conditions on the market. Most of the existing ones only have a pair of position sensors. After cooperating with a timer and a signal processing unit, the speed and rotation angle of the pedal crank shaft are calculated. It cannot set the origin of the rotation angle, so as to recalibrate the rotation angle of the pedal crank shaft. Therefore, it is impossible to provide accurate electric-assisted torque, and the provided electric-assisted torque is only to multiple the measured torque value by 1 or a fraction less than 1, and then adjust.

For measurement of the torque, Taiwanese patent No. 1604992 discloses a configuration method and device for a strain detector that uses push and pull forces to cause the measured body to generate deformation signals. The strain detector is installed to the bicycle frame to measure its pulling force or pushing force data, it will not cause a feedback signal to the strain detector when the motor is running. When the rider applies a pushing force or a pulling force to the bicycle, the strain detector is deformed, and a difference of the deformation is measured, and the deformation signal is used to control the motor to provide a proportional force to the bicycle. However, because the strain detector is installed to the bicycle frame, the shape and the structure of the bicycle frame needs to have a mechanical analysis and calculation so as to have a precise torque. In other words, its applicability is still limited.

Another torque sensing device for electric bicycles known to applicant is disclosed in Chinese patent No. 2441731Y, which includes a torque sensor installed to the seat tube. The torque sensor is mainly used to measure the torque of the bicycle chain which floats up due to the increase of pedaling torque when riding. The position that the torque sensor is installed may have interference signals, making it difficult to be effectively applied to the market.

Most of the pedaling torque sensors are installed on the crankshaft, pedal or frame inside the motor located at a middle portion of the bicycle frame. However, the detected value of the measured torque will be interfered by a lot signals that may affect the precision of the value. Vibration of the bicycle and the postures of the rider can affect the detected value of the torque, therefore the accuracy of torque measurement is not satisfied. Even after complex calculation processing, a precise result of the measurement cannot be quickly, accurately and effectively provided, and an improper torque may be wrongly provided and will cause riding safety and comfort concerns. Most of the motor casings used to install the motor therein are composed of two C-shaped casings that are pivotally connected to each other. Each of the two halves has a face that extends outward, and locking members extend the faces and to connect the two halves together. However, it is noted that there is gap between the two faces of the two halves and vibration will shake the two halves to loose the nuts and the bolts between the two halves, and the vibration will create noise and affect the sensor operation. Once the torque sensor cannot precisely detect the torque that is correctly provided to the motor, the pedaling may not be improved as desired. The torque that the electric power boosts is also unstable to affect riding safety and comfort.

The present invention intends to provide a securing device for securing a mid-mount motor of an electric bicycle to eliminate the shortcomings mentioned above.

### SUMMARY OF THE INVENTION

The present invention relates to a securing device for securing a mid-mount motor of an electric bicycle, and comprises a casing having a first part and a second part, wherein the first part includes a room formed therein for accommodating a motor therein. The first part includes at least one flange extending radially therefrom. At least one first hole is formed through the at least one flange. The second part is mounted to the first part and has an end face facing the at least one flange. A slot is formed in the second part and has a second hole formed in the inner bottom of the slot. A first locking member extends through the first and second holes, and is connected to an engaging member located in the slot. Preferably, the first part is a circular part or a curved part, and the second part is a curved part.

Preferably, the engaging member in the slot does not rotate to combine the first part with the second part.

Preferably, the engaging member is a nut, and the first locking member is a bolt.

Preferably, the casing includes an opening formed to one of two ends thereof. At least one first bore is formed to an outside of the casing and located along an outer periphery of the opening. A cap is mounted to the opening and includes a second bore. The at least one first bore is located corresponding to the second bore.

Preferably, at least one second locking member extends through the second bore and is connected to the at least one first bore.

Preferably, the second part is connected to a bike frame. Preferably, the casing is connected to a bottom bracket of a bike frame.

Preferably, the second part is connected to a bike frame of a bike. The motor is connected to the bike and drives the bike. A deformation sensor is connected to the casing. When a pedaling torque is applied to the casing, the deformation sensor detects the deformation. A processor is electrically connected to the deformation sensor and the motor. The processor demands the motor to provide a torque to the bike.

Preferably, the deformation sensor is a strain gauge or a displacement sensor.

The primary object of the present invention is to provide a securing device for securing a mid-mount motor of an electric bicycle, and the securing device is suitable for securing the casing to a seat tube. Multiple deformation sensors are installed to the casing to provide precise detection data to the processor. The casing is composed of a first part and a second part which is connected to the first part by locking members cooperated with multiple nuts which are accommodated in multiple slots formed in the second part. The nuts do not rotate to ensure that the first and second parts are securely connected with each other, so that vibration from the ground does not affect the detection of the deformation sensors. The processor provides precise torque to assist the rider to operate the bike. The nuts are located in the slots of the second part to enhance aesthetic purpose of the casing. The heat from the motor is transferred to the bike frame because the first and second parts are securely connected to each other. In addition, because the first and second parts are secured with each other so as to reduce gaps between the first and second parts to further reduce noise and wrong signals transferred to the deformation sensors. The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the components of detection device of a mid-mount motor for a bike;

FIG. 2 is a perspective view to show the casing of the present invention;

FIG. 3 is a perspective view to show another embodiment of the casing of the present invention;

FIG. 4 is an exploded view of the casing and the securing device of the present invention;

FIG. 5 is an end cross sectional view of the casing of the present invention;

FIG. 6 is a perspective view to show that the casing of the present invention is installed to the bottom bracket of a bike;

FIG. 7 shows that the deformation sensor is located on outside of the first part of the casing of the present invention, and

FIG. 8 shows that the deformation sensor is located on an inside of the first part of the casing of the present invention.

### DETAILED DESCRIPTION OF THE PREFERRED EMBODIMENT

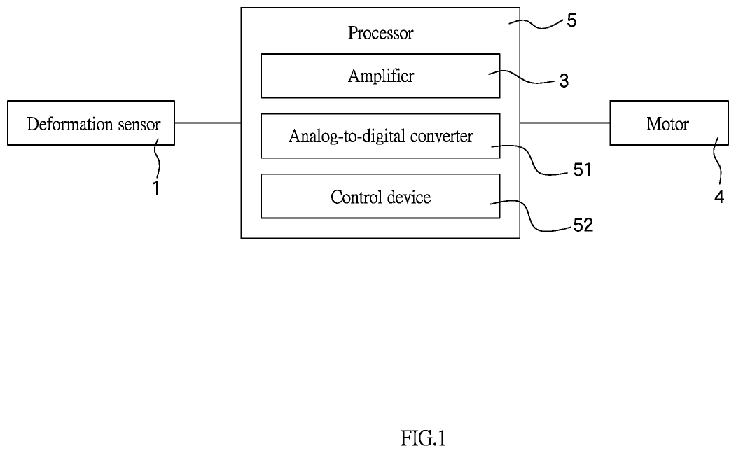

Referring to FIGS. 1 to 3, the securing device for securing a mid-mount motor of an electric bicycle of the present invention comprises a deformation sensor 1 as shown in FIG. 1, and the deformation sensor 1 is installed to the seat tube 21 of a bike 2, when a rider rides the bike 2, the deformation sensor 1 detects the force that the rider applies to the bike 2. The deformation sensor 1 is a strain gauge or a displacement sensor, and includes two sensors 11 which are installed diametrically to the inner periphery or the outer periphery of the seat tube 21.

When the rider rides the bike 2, the seat tube is slightly deformed along with postures change of the rider. The structural strength of the seat tube is strong enough so that the seat tube does not affected by temperature or pressure so as to provide precise date to be detected by the deformation sensor 1. Preferably, the deformation sensor 1 is installed to the bottom bracket of the bike frame 24 because the bottom bracket is mainly deformed and can be precisely detected. In one embodiment, the deformation sensor 1 is electrically connected to an amplifier 3.

A motor 4 is used to provide an assistance torque to the bike 2, and preferably, the motor 4 is a mid-mount motor 4 that is located at a middle portion of the bike 2 to provide stability to the bike 2.

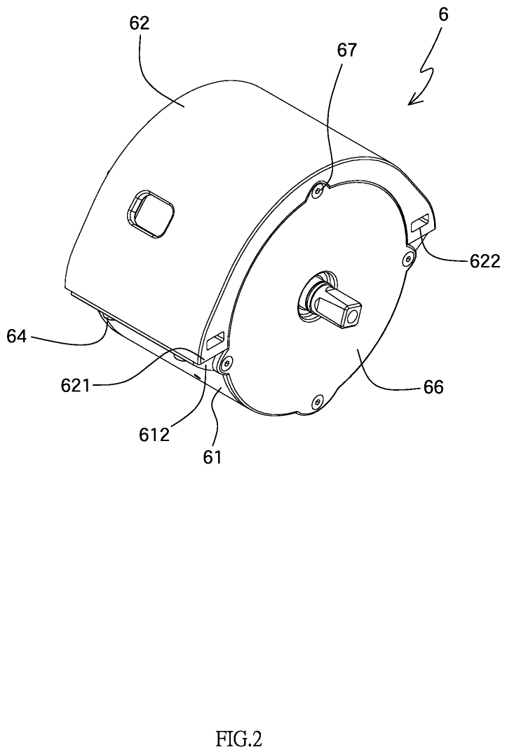

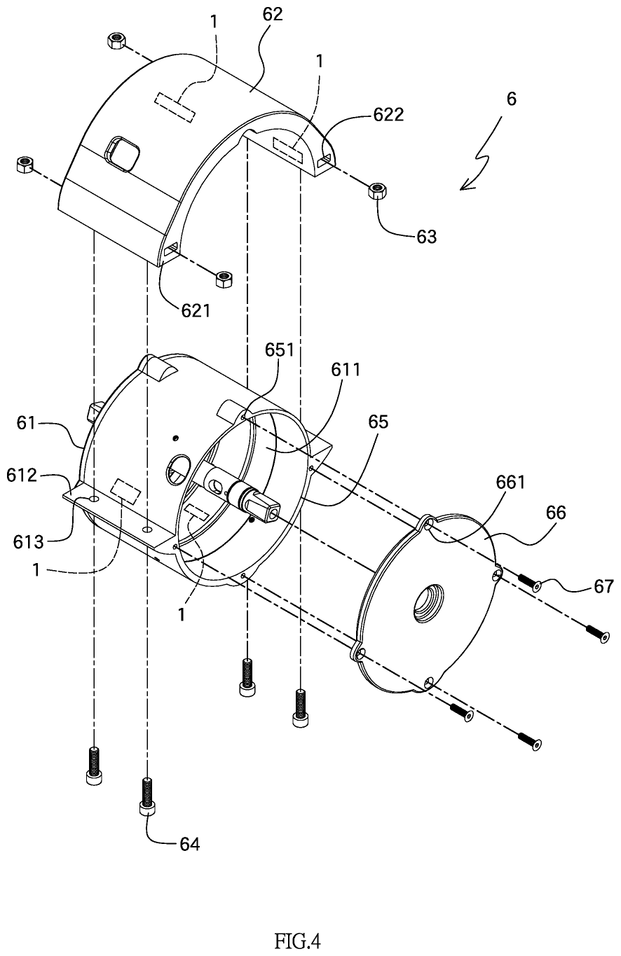

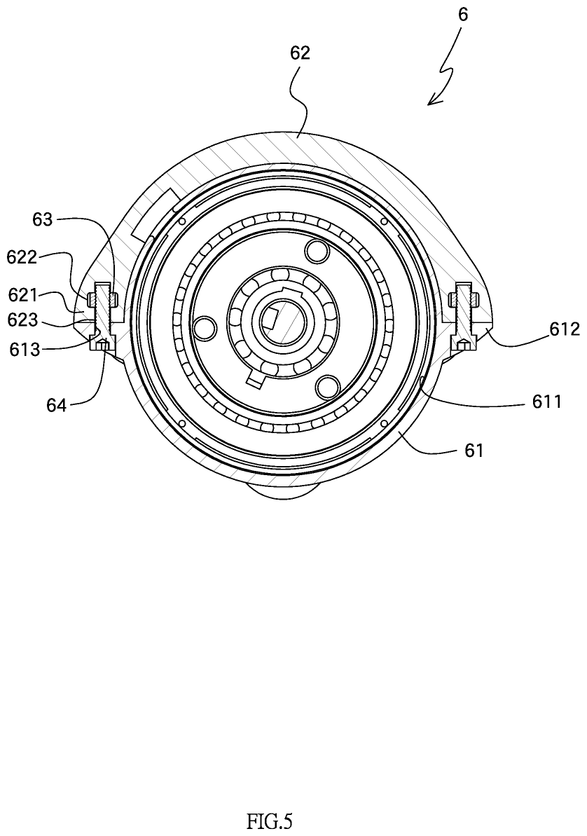

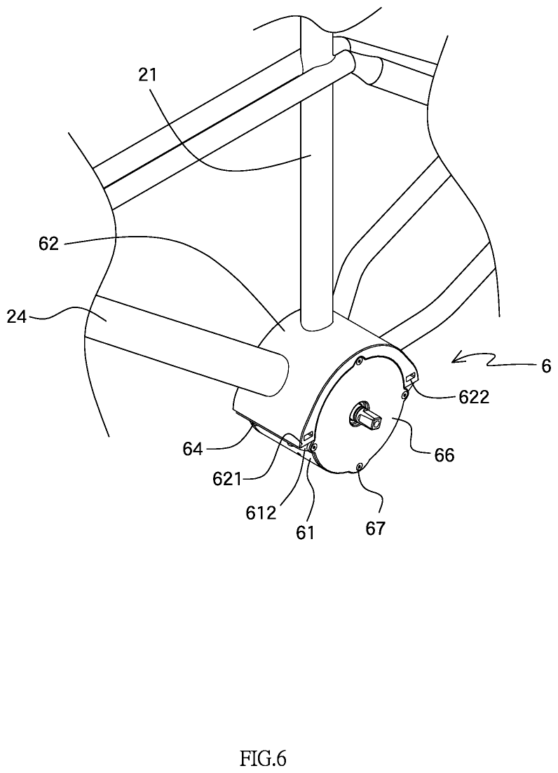

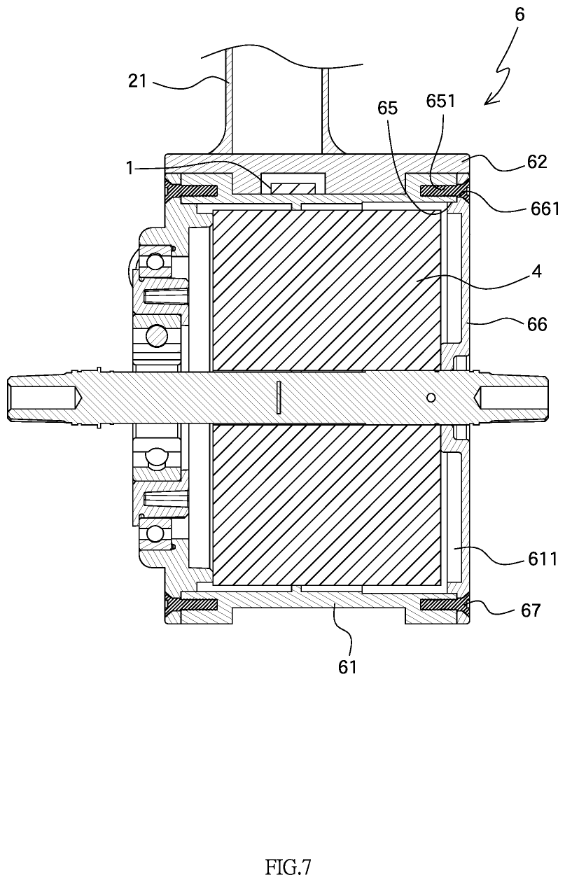

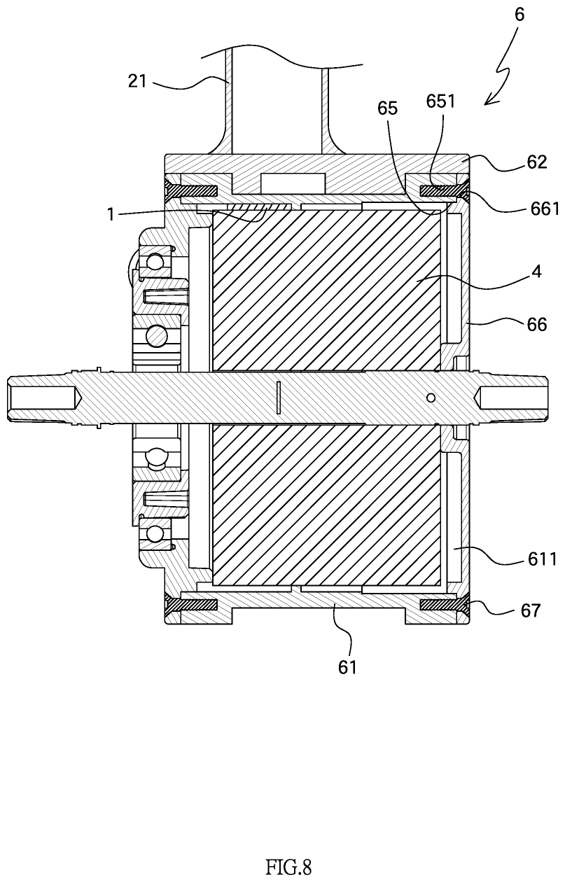

A processor 5 is electrically connected to the motor 4 and the deformation sensor 1. The processor 5 includes the amplifier 3, an analog-to-digital converter 51 and a motor driving and control device 52 so as to convert analog signals from the deformation sensor 1 and the motor 4 into digital signals. The detected signals are analyzed and the processor 5 demands the motor 4 to provide assistance torque to the bike 2. As shown in FIGS. 2 to 7, the deformation sensor 1 is connected to the first part 61 or the second part 62 of the casing 6 that is located at the outside of the motor 4. The motor 4 together with the casing 6 are connected to the bottom bracket of the bicycle frame. Alternatively, the casing 6 is formed to the seat tube 21 of the bike frame 24 as shown in FIG. 6. The motor 4 is protected within the casing 6. The force that the rider applies to the bike 2 makes deformation to the casing 6, and the deformation sensors 1 as shown in FIGS. 4, 7 and 8 detect the deformation. The deformation sensors 1 can be installed to the inside of outside of the first and second parts 61, 62 so as to precisely detect the deformation. The first part 61 includes the first holes 613, and the second part 62 includes the second holes 623 so that first locking members 64 extend through the first holes 613 and the second holes 623, and are connected to the engaging members 63 to securely connect the first part 61 to the second part 62. The under face of the second part 62 snugly contacts the first part 61. When the rider rides the bike 2, the force is transferred to the first part 61, the second part 62 or the seat tube 21 via the pedals. The first part 61, the second part 62 and the seat tube 21 are slightly deformed and the deformation is detected by the deformation sensors 1. The processor 5 processes and analyzes the deformation to calculate the pedaling force of the rider. The casing 6 is composed of the first part 61 and the second part 62, and the casing 6 does not have gaps so that the deformation sensors 1 are able to precisely detect the deformation. The heat generated from the motor 4 is transferred to the bike frame 24 to increase efficiency of the operation of the motor 4.

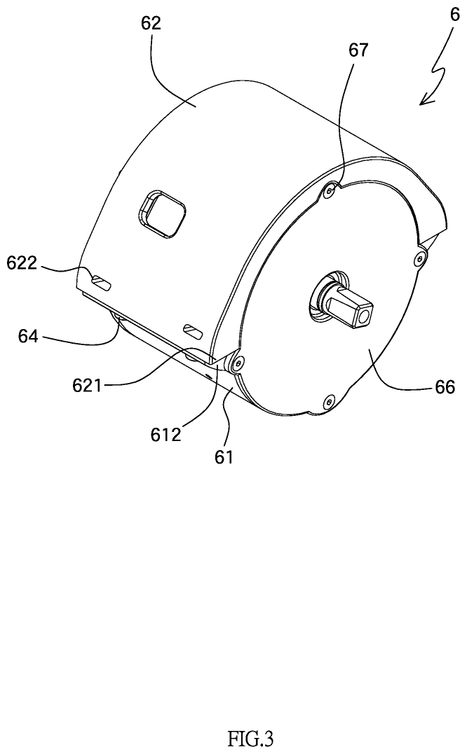

Therefore, the installation of the deformation sensors 1 to the seat tube 21 or the casing 6 is simple and easy. The pedaling force from the rider can be precisely detected. Preferably, as shown in FIGS. 2 to 8, the casing 6 is composed of the first part 61 and the second part 62. The deformation sensors 1 are installed to the outside or inside of the first part 61 or the second part 62. The first part 61 includes a room 611 formed therein for accommodating the motor 4 therein. The first part 61 includes two flanges 612 extending radially therefrom, and each flange 612 includes two first holes 613 formed therethrough. The second part 62 is a curved part and radially mounted to the first part 61. The second part 62 includes two end faces 621 facing the two flanges 612. The second part 62 includes a front end and a rear end, wherein two slots 622 are formed in each of the front end and the rear end. A second hole 623 is formed in the inner bottom of each of the slots 622, as shown in in FIG. 2. Alternatively, as shown in FIG. 3, the slots 622 are formed radially in the second part 62. A first locking member 64 extends through the correspondent first and second holes 613, 623, and is connected to the engaging member 63 located in each of the slots 622. It is noted that, as shown in FIGS. 2 and 4, the slots 622 are formed axially in the front end and the rear end of the second part 62, and the engaging members 63 are located in the slots 622, so that the first locking members 64 are not visible from outside of the second part 62 as shown in FIGS. 2 and 4.

In this embodiment, the engaging member 63 is a nut of any known shape, at least one end face of the engaging member 63 is matched with the inner bottom of the slot 622 corresponding thereto. The first locking member 64 is a bolt. The engaging member 63 in the slot 622 does not rotate so that the first locking member 64 does not loose to combine the first part 61 with the second part 62. Therefore, the motor 4 in the casing 6 is stable and secured. The engaging members 63 are hidden in the slots 622, and the first locking members 64 extend through the first holes 613 from the underside of the flanges 612 so that the engaging members 63 and the first locking members 64 are hidden to meet the aesthetic purposes.

The casing 6 is made of hard or anti-worn material so as to protect the motor 4 received in the casing 6. The engaging members 63 are received in the slots 622, and the first locking members 64 are cooperated with a washer to be securely connected to the engaging members 63.

The first part 61 is a circular part or a curved part, and the second part 62 is a curved part. When the first part 61 is a curved part, the second part 62 is made of elastic material so that the second part 62 is snugly mounted to the first part 61 to well position the motor 4. When the first and second parts 61, 62 are both a curved part, the motor 4 is snugly sandwiched between the first and second parts 61, 62 by the connection between the first locking members 64 and the engaging members 63. The heat generated from the motor 4 is transferred to the bike frame 24 to increase efficiency of the operation of the motor 4. In addition, the deformation sensors 1 connected to the first part 61 or the second part 62 can precisely detect the deformation because the first and second parts 61, 62 are securely connected to each other.

In one embodiment, the first part 61 may axially mounted to the motor 4. In another embodiment, as shown in FIG. 4, the casing 6 includes an opening 65 formed to one of two ends thereof, and four first bores 651 are formed to the outside of the casing 6 and located along the outer periphery of the opening 65. A cap 66 is mounted to the opening 65 and includes four second bores 661 which are located corresponding to the first bores 651. is located corresponding to the second bore 661. Four second locking members 67 extend through the second bores 661 and are connected to the first bores 651. The cap 66 avoids water and dust from entering into the room 611 where the motor 4 is located.

The second part 62 connected to the bike frame 24 as shown in FIGS. 6 7 and 8. Specifically, the casing 6 connected to the bottom bracket of the bike frame 24. While we have shown and described the embodiment in accordance with the present invention, it should be clear to those skilled in the art that further embodiments may be made without departing from the scope of the present invention.

What is claimed is:

1. A securing device for securing a mid-mount motor of an electric bicycle, comprising:
a casing having a first part and a second part, the first part including a room formed therein for accommodating a motor therein, the first part including at least one flange extending radially therefrom, at least one first hole formed through the at least one flange, and
the second part mounted to the first part and having an end face facing the at least one flange, a slot formed in the second part and having a second hole formed in an inner bottom of the slot, a first locking member extending through the first and second holes and connected to an engaging member located in the slot.

2. The securing device as claimed in claim 1, wherein the first part is a circular part or a curved part, the second part is a curved part.

3. The securing device as claimed in claim 1, wherein the engaging member in the slot does not rotate to combine the first part with the second part.

4. The securing device as claimed in claim 3, wherein the engaging member is a nut, the first locking member is a bolt.

5. The securing device as claimed in claim 1, wherein the casing includes an opening formed to one of two ends thereof, at least one first bore is formed to an outside of the casing and located along an outer periphery of the opening, a cap is mounted to the opening and includes a second bore, the at least one first bore is located corresponding to the second bore.

6. The securing device as claimed in claim 5, wherein at least one second locking member extends through the second bore and is connected to the at least one first bore.

7. The securing device as claimed in claim 1 further comprising a bike which includes a bike frame, the second part connected to the bike frame.

8. The securing device as claimed in claim 1 further comprising a bike including a bike frame, the bike frame including a bottom bracket, the casing connected to the bottom bracket of the bike frame.

9. The securing device as claimed in claim 1, wherein the second part is connected to a bike frame of a bike, the motor is connected to the bike and drives the bike, a deformation sensor is connected to the casing, when a pedaling torque is applied to the casing, the deformation sensor detects the deformation, a processor is electrically connected to the deformation sensor and the motor, the processor demands the motor to provide a torque to the bike.

10. The securing device as claimed in claim 9, wherein the deformation sensor is a strain gauge or a displacement sensor.
